(19) United States
(12) Patent Application Publication
(10) Pub. No.: US 2025/0388503 A1
(43) Pub. Date: Dec. 25, 2025

(54) CLEANING PLANT WITH WATER TREATMENT PLANT AND METHOD FOR WATER TREATMENT

(71) Applicant: Ideen Schmiede Pauli eGbR, Witzmannsberg (DE)

(72) Inventor: Philipp PAULI, Witzmannsberg (DE)

(21) Appl. No.: 19/243,479

(22) Filed: Jun. 19, 2025

(30) Foreign Application Priority Data
Jun. 19, 2024 (DE) 10 2024 117 292.4

(51) Int. Cl. C02F 9/00; C02F 1/00; C02F 1/24; C02F 1/42; C02F 1/44; C02F 1/66; C02F 11/127; C02F 103/38

(52) U.S. Cl. CPC C02F 9/00; C02F 1/008; C02F 1/004; C02F 1/24; C02F 1/42; C02F 1/444; C02F 1/66; C02F 11/127; C02F 2103/38; C02F 2201/005; C02F 2301/046

(57) ABSTRACT

The invention relates to a water treatment plant for the treatment of a first process water of a first process water circuit and a second process water of a second process water circuit, comprising a first purification circuit and a second purification circuit. Further, the invention relates to a purification plant comprising two process water circuits and a water treatment plant of this kind, and a method for water treatment of process water of two process water circuits.

The invention relates to a water treatment plant for two process water circuits, comprising a first purification circuit for the purification of a first process water of a first of the process water circuits and a second purification circuit for the purification of a second process water of the second process water circuit. Furthermore, the invention relates to a purification plant comprising two process water circuits and a water treatment plant of this kind, and a method for water treatment of process water of two process water circuits.

From the state of the art, process water treatment plants are known in various embodiments and are used to treat process water with the aim of minimizing the consumption of water as a natural resource.

For example, a purification plant for PET flakes is known from the state of the art. In this case, the water used for purification is enriched with various substances. The PET flakes are crushed and roughly purified in a first process water circuit, in particular in the so-called mill circuit. Adhesive residues and label residues are removed from the flakes by the added substances, for example sodium hydroxide solution, and by a temperature increase of up to 80 degrees Celsius. In a subsequent second process water circuit, in particular a so-called post-washing circuit, the PET flakes are further purified and then dried. A second process water is used to purify the PET flakes. The PET flakes are separated from the second process water and prepared for further processing.

However, such purification plants generally have a high water demand.

The object of the invention is to provide a water treatment plant for the purification of a first process water of a first process water circuit and of a second process water of a second process water circuit, which enables sufficient purification of the two process waters in a simple manner. Furthermore, it is the object of the present invention to provide a purification plant comprising two process water circuits and a water treatment plant of this kind, and a method for water treatment of process water of two process water circuits.

According to the invention, this object is attained by the water treatment module having the features of patent claim 1, the purification plant having the features of patent claim 9 and the method having the features of patent claim 10.

According to the invention, a water treatment plant for the treatment of a first process water of a first process water circuit and for the treatment of a second process water of a second process water circuit is provided, which can be operated in particular in bypass mode to the first process water circuit and to the second process water circuit. The first purification circuit comprises a process water filtration module, a first flotation module for oxygen enrichment and aeration, and a first microfiltration module. The first process water can be fed into the process water filtration module through a first process water supply line. The process water filtration module is connected to the first flotation module via a first permeate line. The first flotation module is connected to the first microfiltration module via a first residual process water line. Through a second permeate line, a second permeate can be fed or returned back from the first microfiltration module into the first process water circuit. The second purification circuit comprises a second flotation module for oxygen enrichment and aeration and a second microfiltration module. Through a second process water discharge line, the second process water can be fed into the second flotation module. The second flotation module is connected to the second microfiltration module via a second residual process water line. Through a third permeate line and/or a fourth permeate line, a third permeate can be fed or returned back from the second microfiltration module into the first process water circuit and/or into the second process water circuit.

The central idea of the invention is that the first process water can be fed into the process water filtration module via the first process water supply line, the first process water being separatable into a first permeate and a first retentate in said process water filtration module. Through a first permeate line, the first permeate can be fed from the process water filtration module into the first flotation module. In the first flotation module, the first permeate can be separated into a first solids separation and a first residual process water. The first residual process water can then be fed from the first flotation module into the first microfiltration module through the first residual process water line, the residual process water being separatable into a second permeate and a second retentate in the first microfiltration module. The second permeate can be returned back from the first microfiltration module into the first process water circuit through the second permeate line.

In the second purification circuit, the second process water of the second process water circuit can be fed into the second flotation module through the second process water supply line. In the second flotation module, the second process water can be separated into a second solids separation and a second residual process water. Through the second residual process water line, the second residual process water is fed from the second flotation module into the second microfiltration module. In the second microfiltration module, the second residual process water can be separated into a third permeate and a third retentate. The third permeate in the second microfiltration module can be fed into the first process water circuit and/or the second process water circuit through a third permeate line and/or a fourth permeate line.

This ensures sufficient purification of the first process water and the second process water, i.e., such purification that the process water can be reused in the process water circuits and/or can be discharged into a wastewater treatment plant, in particular in a bypass mode to the first process water circuit and the second process water circuit.

In an exemplary embodiment of the water treatment plant according to the invention, the process water filtration module is connected to at least one mud treatment module via a first retentate line, the first flotation module is connected to at least one mud treatment module via a first solids separation line and the first microfiltration module is connected to at least one mud treatment module via a second retentate line, the second flotation module is connected to at least one mud treatment module via a second solids separation line and/or the second microfiltration module is connected to at least one mud treatment module via a third retentate line.

For example, the process water filtration module has a degree of filtration of less than or equal to 180 μm, in particular at least approximately 180 μm.

In a preferred embodiment, the water treatment plant according to the invention comprises a control module unit and a data acquisition unit. An amount of the first process water in the first process water circuit can be detected by means of the data acquisition unit.

For example, if the control unit detects that the recorded amount of the process water of the process water circuit is less than or equal to a defined value, it controls a control valve in such a manner that the third permeate can be fed from the second microfiltration module into the first process water circuit and it is ruled out or prevented that the third permeate is fed into the second process water circuit.

For example, if the control unit detects that the amount of the process water in the first process water circuit is greater than the defined value, the control valve can be controlled by means of the control module in such a manner that the third permeate can be fed from the second microfiltration module into the second process water circuit and the third permeate is prevented from being fed into the first process water circuit.

In a preferred embodiment of the water treatment plant according to the invention, the at least one mud treatment module comprises a two-phase centrifuge.

By means of the two-phase centrifuge, the first retentate, the second retentate, the third retentate, the fourth retentate, the first solids separation and/or the second solids separation can be separated into a solid phase and a liquid phase.

In an exemplary embodiment, the water treatment plant according to the invention comprises at least one liquid phase supply line through which the liquid phase can be fed into the first process water circuit and/or into the second process water circuit.

In an exemplary embodiment, the water treatment plant according to the invention comprises at least one pipe water supply line. Through the pipe water supply line, pipe water can be fed into the first microfiltration module and/or into the second microfiltration module.

The water treatment plant according to the invention can comprise at least one pipe water treatment module for the treatment of pipe water or tap water, in particular for a water replenishment.

The at least one pipe water treatment module can be configured such that pipe water in the at least one pipe water supply line flows through the at least one pipe water treatment module, in particular before the pipe water is fed into the first microfiltration module and/or into the second microfiltration module.

For example, the pipe water treatment module comprises a water softening plant, in particular a duplex water softening plant.

The water treatment module can comprise a pipe water filtration module.

As the pipe water filtration module, the process water filtration module can be used, for example.

For example, the pipe water treatment module has an enrichment module.

The pipe water can be enriched, in particular with sulfuric acid and/or sodium hydroxide solution, in the enrichment module.

Furthermore, the present invention relates to a purification plant which comprises two process water circuits and a previously described water treatment plant.

Furthermore, the invention relates to a method for water treatment of process water of two process water circuits. The method for the water treatment of a first of the process water circuits comprises the following steps:
1.a. supplying a first process water of the first process water circuit to a process water filtration module via a first process water supply line, the first process water being separated into a first permeate and a first retentate in said process water filtration module;
1.b.i feeding the first permeate from the process water filtration module into a first flotation module via a first permeate line, the first permeate being separated into a first solids separation and a first residual process water in said first flotation module;
1.c.i. feeding the first residual process water from the first flotation module into a first microfiltration module via a first residual process water line, the residual process water being separated into a second permeate and a second retentate in said first microfiltration module; and
1.d.i. discharging the second permeate from the first microfiltration module into the first process water circuit via a second permeate line;

the method for water treatment of the second process water circuit comprising the following steps:
2.a. supplying a second process water of the second process water circuit to the first flotation module or a second flotation module via a second process water supply line, the second process water being separated into a second solids separation and a second residual process water in the first flotation module or the second flotation module;
2.b.i. feeding the second residual process water from the first flotation module or the second flotation module into the first microfiltration module or a second microfiltration module via the first residual process water line or a second residual process water line, the second residual process water being separated into a third permeate and a third retentate in the first microfiltration module or a second microfiltration module; and
2.c.i. discharging the third permeate from the first microfiltration module or the second microfiltration module into the first process water circuit and/or the second process water circuit via the second permeate line, a third permeate line and/or fourth permeate line.

In an exemplary embodiment, the method according to the invention further comprises at least one of the following steps:
1.b.ii. discharging the first retentate from the process water filtration module to a first mud treatment module via a first retentate line;
1.c.ii. discharging the first solids separation from the first flotation module into the first mud treatment module and/or a second mud treatment module via a first solids separation line;
1.d.ii. discharging the second retentate from the first microfiltration module via a second retentate line in the first mud treatment module, the second mud treatment module and/or a third mud treatment module;
2.b.ii. discharging the second solids separation from the first flotation module and the second flotation module into the first mud treatment module, the second mud treatment module, the third mud treatment module and/or a fourth mud treatment module via the first solids separation line and a second solids separation line, respectively;
2.c.ii. discharging the third retentate from the first microfiltration module and the second microfiltration module into the first mud treatment module, the second mud treatment module, the third mud treatment module, the fourth mud treatment module and/or a fifth mud treatment module via the second retentate line and a third retentate line, respectively.

In a preferred embodiment, it is determined before step 2.c.i. in the method according to the invention whether an amount of the process water in the first process water circuit is less than or equal to a defined value. If the determined amount of the process water in the first process water circuit is less than or equal to the defined value, the third permeate is fed from the second microfiltration module into the first process water circuit. If the amount of the process water in the first process water circuit is greater than the defined value, the third permeate is fed from the second microfiltration module into the second process water circuit.

In a preferred embodiment of the method according to the invention, the first retentate, the second retentate, the third retentate, the fourth retentate, the first solids separation and/or the second solids separation is/are (each) separatable into a solid phase and a liquid phase in the at least one mud treatment module by means of a two-phase centrifuge.

The liquid phase can be fed into the first process water circuit and/or into the second process water circuit via a liquid phase supply line.

In an exemplary embodiment of the method according to the invention, pipe water is fed into the first microfiltration module and/or into the second microfiltration module via a first pipe water supply line and/or a second pipe water supply line, respectively.

For example, the pipe water flows through a pipe water treatment module for the treatment of the pipe water or tap water for a water replenishment, in particular before being fed into the first microfiltration module and/or into the second microfiltration module.

The throughflow of the pipe water treatment module can comprise a throughflow of a water softening plant, in particular a duplex water softening plant, a throughflow of a pipe water filtration module, in particular of the process water filtration module, and/or a throughflow of an enrichment module.

In the enrichment module, the pipe water is enriched with sulfuric acid and/or sodium hydroxide solution, for example.

Further advantages and advantageous embodiments of the subject matter of the invention can be found in the description, the drawing and the patent claims.

Exemplary embodiments of a water treatment plant and a method according to the invention are illustrated schematically simplified in the drawing and are described in more detail hereinafter.

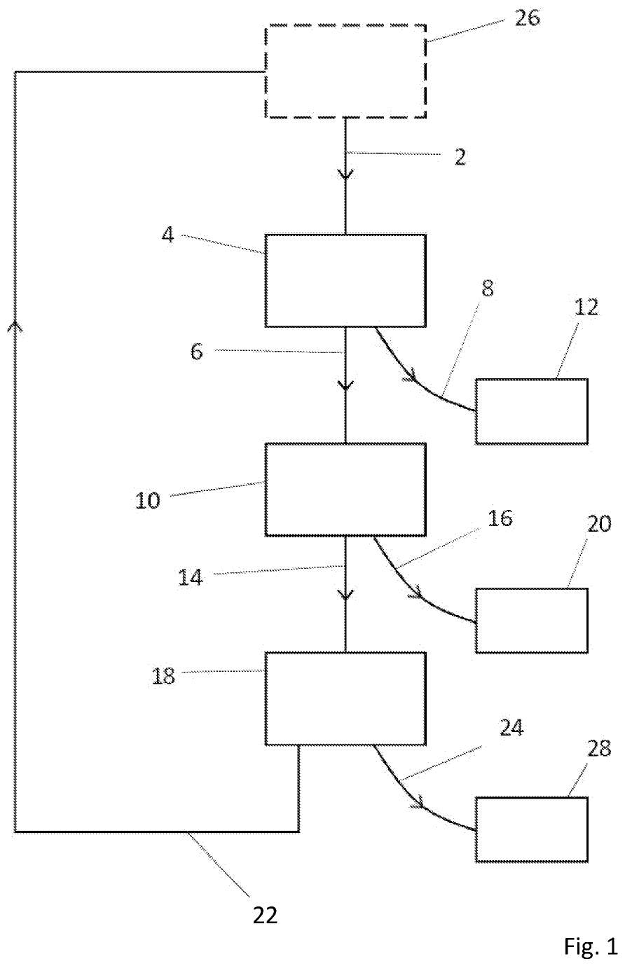

FIG. 1 shows a schematic view of a first purification circuit of a first water treatment plant according to the invention;

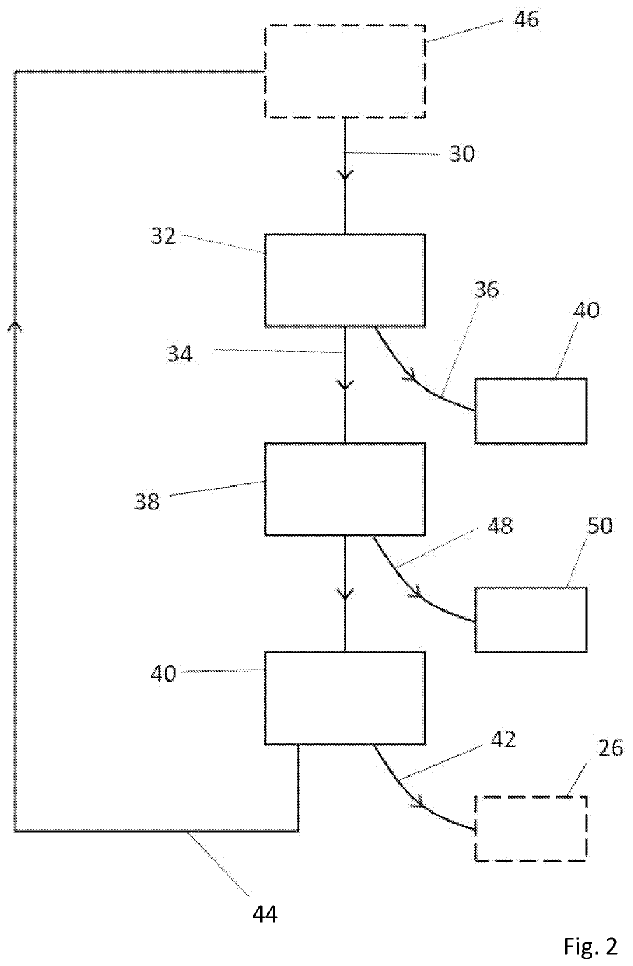

FIG. 2 shows a schematic view of a second purification circuit of the first water treatment plant according to the invention;

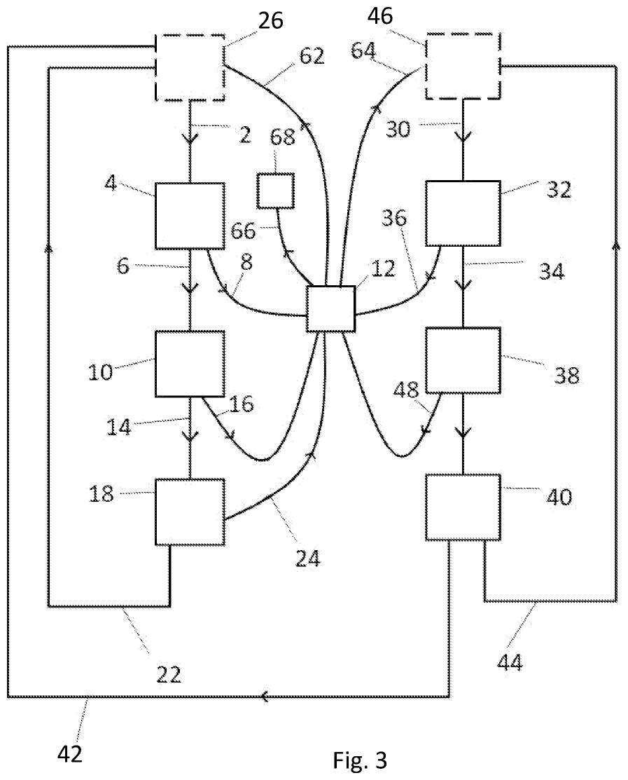

FIG. 3 shows a schematic view of a second water treatment plant according to the invention;

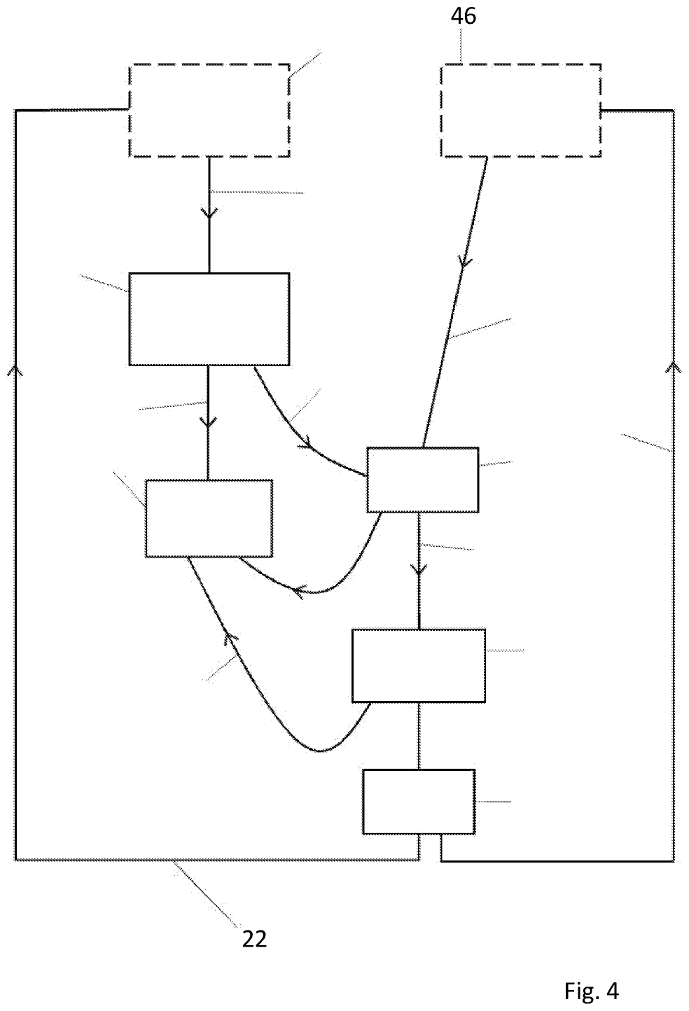

FIG. 4 shows a schematic view of a third water treatment plant according to the invention;

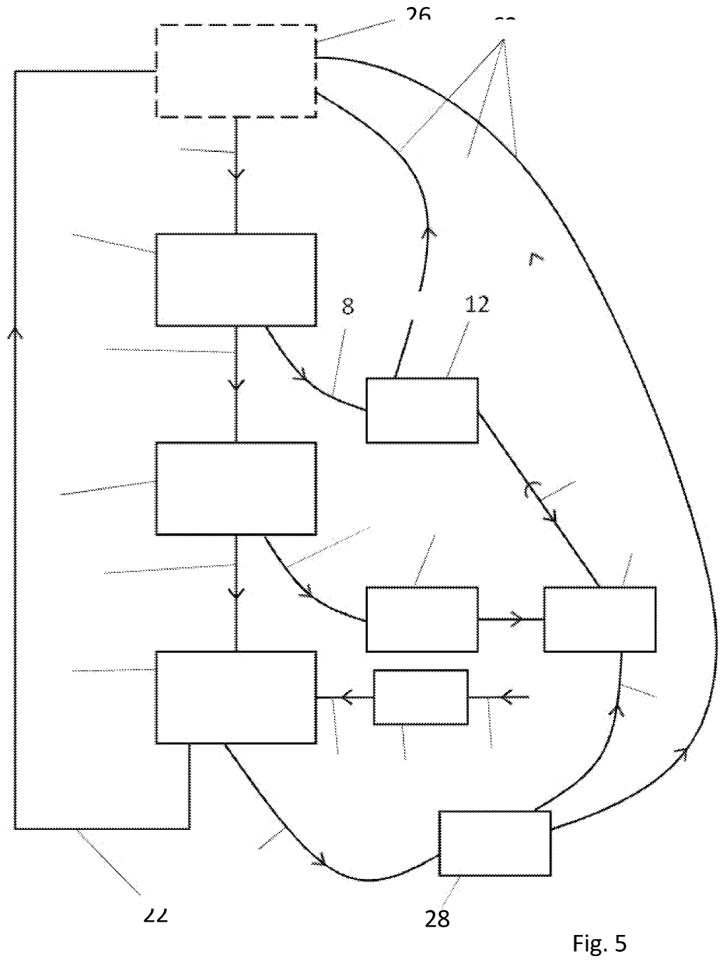

FIG. 5 shows a schematic view of another first purification circuit of a fourth water treatment plant according to the invention;

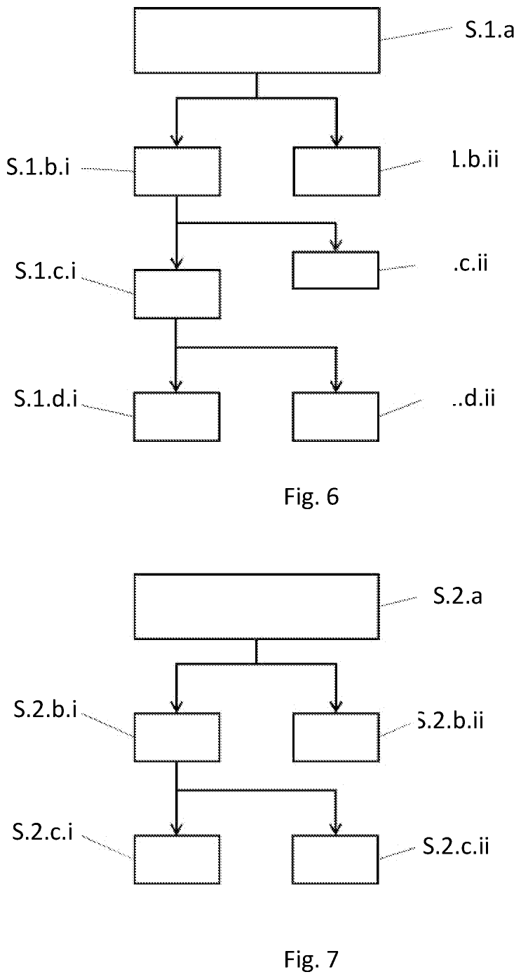

FIG. 6 shows a schematic view of steps of a first purification circuit of a method according to the invention; and

FIG. 7 shows a schematic view of steps of a second purification circuit of the method according to the invention.

The FIGS. 1 and 2 show a schematically simplified illustration of a first purification circuit and a second purification circuit, respectively, of a first water treatment plant according to the invention.

As can be seen in FIG. 1, the first purification circuit comprises a process water filtration module 4, a first flotation module 10 and a first microfiltration module 18.

Through a first process water supply line 2, the first process water can be fed into the process water filtration module 4. The first process water filtration module 4 can thus be connected to a first process water circuit 26 via the process water supply line 2. The process water filtration module 4 is connected to the first flotation module 10 via a first permeate line 6. The first flotation module 10 is connected to the first microfiltration module 18 via a first residual process water line 14. Through a second permeate line 22, a second permeate can be fed or returned back from the first microfiltration module 18 into the first process water circuit 26.

The process water filtration module 4 is connected to a first mud treatment module 12, a second mud treatment module 20 and/or a third mud treatment module 28 via a first retentate line 8, the first flotation module 10 is connected to a first mud treatment module 12, a second mud treatment module 20 and/or a third mud treatment module 28 via a first solids separation line 16 and the first microfiltration module 18 is connected to a first mud treatment module 12, a second mud treatment module 20 and/or a third mud treatment module 28 via a second retentate line 24.

As can be seen in FIG. 2, the second purification circuit has a second flotation module 32 and a second microfiltration module 38.

Through a second process water supply line 30, which is connected to the second process water circuit 46, second process water of the second process water circuit 46 can be fed into the second flotation module 32. The second flotation module 32 is connected to the second microfiltration module 38 via a second residual process water line 34. Through a third permeate line 42 and a fourth permeate line 44, a third permeate can be fed from the second microfiltration module 38 into the first process water circuit 26 and/or the second process water circuit 46, respectively.

The second flotation module 32 is connected to a fourth mud treatment module 40 via a second solids separation line 36 and the second microfiltration module 38 is connected to a fifth mud treatment module 50 via a third retentate line 48.

FIG. 3 shows a schematically simplified view of a second water treatment plant according to the invention. The second water treatment plant essentially corresponds to the first water treatment plant shown in the FIGS. 1 and 2. Consequently, only the distinguishing features are explained below, whereby the above explanations apply accordingly.

The second water treatment plant differs from the first water treatment plant in that the first flotation module 10 is also connected to the first mud treatment module 12 via the first solids separation line 16, the first microfiltration module 18 is also connected to the to the first mud treatment module 12 via the second retentate line 24, the second flotation module 32 is also connected to the first mud treatment module 12 via the second solids separation line 36 and the second microfiltration module 38 is also connected to the first mud treatment module 12 via the third retentate line 48. Thus, instead of the first mud treatment module 12, the second mud treatment module 20, the third mud treatment module 28, the fourth mud treatment module 40 and the fifth mud treatment module 50, the second water treatment plant comprises only one, in particular the first mud treatment module 12, into which all of the mud or retentate from the water purification process is fed.

In contrast to the embodiment shown in FIG. 3, it is also conceivable that the first purification circuit and the second purification circuit each comprise exactly one mud treatment module.

The first mud treatment module 12 is a two-phase centrifuge. The first retentate, the second retentate, the third retentate, the fourth retentate, the first solids separation and the second solids separation can therefore be separated into a solid phase and a liquid phase in the first mud treatment module 12.

Via a first liquid phase supply line 62 and a second liquid phase supply line 64 the liquid phase can be fed into the first process water circuit and/or into the second process water circuit.

It is also conceivable that the entire liquid phase is supplied to one of the two process water circuits 26, 46 and therefore only one of the two liquid phase supply lines 62 and 64 is provided.

The solid phase can be discharged into a capture receptacle 68 via a solid phase discharge line 66.

In FIG. 4 a third water treatment plant according to the invention is shown in a schematically simplified manner. The third water treatment plant essentially corresponds to the second water treatment plant shown in FIG. 3. Consequently, only the distinguishing features are explained below, whereby the above explanations apply accordingly.

The third water treatment plant differs from the first water treatment plant in that instead of the second microfiltration module 32 and the second microfiltration module 38, the second purification circuit uses the first flotation module 10 and the first microfiltration module 18 of the first purification circuit for the purification of the second process water.

It is also conceivable that only one flotation module or one microfiltration module is used jointly by the first cleaning circuit and the second cleaning circuit.

The third water treatment plant comprises a control unit 52. The control unit 52 receives data of a data acquisition unit. The data is a determined or recorded amount of the first process water in the first process water circuit.

If the control unit 52 detects that the recorded amount of the process water in the first process water circuit 26 is less than or equal to a defined value, the control unit 52 switches a control valve in such a manner that the third permeate is fed from the first microfiltration module 18 into the first process water circuit and it is ruled out that the third permeate is fed into the second process water circuit 46.

If the control unit 52 detects that the amount of the process water in the first process water circuit 26 is greater than the defined value, the control unit 52 switches the control valve in such a manner that the third permeate is fed into the second process water circuit 46 and it is ruled out that the third permeate is fed into the first process water circuit 26.

FIG. 5 shows an additional first purification circuit of a fourth water treatment plant according to the invention. The additional first purification circuit of the fourth water treatment plant essentially correspondents to the first purification circuit of the first water treatment plant shown in FIG. 1. Consequently, only the distinguishing features are explained below, whereby the above explanations apply accordingly.

The additional first purification circuit comprises a pipe water supply line 54 and a pipe water treatment module 56 for the treatment of pipe water or tap water for a water replenishment. Before the pipe water in the pipe water supply line 54 is fed into the first microfiltration module 18, it flows through the pipe water treatment module 56 and is purified there and/or it is enriched with substances.

The first mud treatment module 12, the second mud treatment module 20 and the third mud treatment module 28 separate the first retentate, the first solids separation and the second retentate, respectively, into a solid phase and a liquid phase.

Via a liquid phase supply line 62, the liquid phase can be returned back into the first process water circuit. The solid phase can be discharged into a capture receptacle 68 via a solid phase discharge line 66.

FIGS. 6 and 7 show steps of a first purification circuit 26 and/or of a second purification circuit 46, respectively, of a method according to the invention.

In a step S.1.a., first process water of the first process water circuit 26 is fed into a process water filtration module 4 via a first process water supply line 2. The first process water is separated into a first permeate and a first retentate in the process water filtration module.

Subsequently, in a step S.1.b.i, the first permeate is fed from the process water filtration module 4 into a first flotation module 10 via a first permeate line 6. The first permeate is separated into a first solids separation and a first residual process water in the first flotation module 10. In a step S.1.b.ii., the first retentate is simultaneously discharged from the process water filtration module 4 into a first mud treatment module 12 via a first retentate line 8.

In a step S.1.c.i., the first residual process water is fed from the first flotation module 10 into a first microfiltration module 18 via a first residual process water line 14. Here, the residual process water is separated into a second permeate and a second retentate. In step S.1.c.ii., the first solids separation is discharged from the first flotation module 10 into the first mud treatment module 12 and/or into a second mud treatment module 20 via a first solids separation line 16.

In a step S.1.d.i., the second permeate is fed from the first microfiltration module 18 into the first process water circuit 26 via a second permeate line 22.

In step S.1.d.ii., the second retentate is discharged from the first microfiltration module 18 into the first mud treatment module 12, the second mud treatment module 20 and/or a third mud treatment module 28 via a second retentate line 24.

Parallel to the steps described above, second process water of the second process water circuit 46 is purified by performing the following:

In a step S.2.a., the second process water is fed into the first flotation module 10 or a second flotation module 32 via a second process water supply line. In the first flotation module 10 or the second flotation module 32, the second process water is separated into a second solids separation and a second residual process water.

In step S.2.b.i., the second residual process water is fed from the first flotation module 10 or the second flotation module 32 into the first microfiltration module 18 and a second microfiltration module 38, respectively, via the first residual process water line 14 and a second residual process water line 34, respectively. Here, the second residual process water is separated into a third permeate and a third retentate. In step S.2.b.ii., the second solids separation is fed from the first flotation module 10 via the first solids separation line or from the second flotation module 32 via a second solids separation line 36 into the first mud treatment module 12, the second mud treatment module 20, the third mud treatment module 28 and/or a fourth mud treatment module 40.

In step S.2.c.i., the third permeate is fed from the first microfiltration module 18 and the second microfiltration module 38 into the first process water circuit 26 and/or the second process water circuit 46 via the second permeate line 22 or a third permeate line 42 and/or a fourth permeate line 44. In step S.2.c.ii, the third retentate is discharged from the first microfiltration module 18 and the second microfiltration module 38 into the first mud treatment module 12, the second mud treatment module 20, the third mud treatment module 28, the fourth mud treatment module 40 and/or a fifth mud treatment module 50 via a third retentate line 48.

### REFERENCE SIGNS

2 first process water supply line
4 process water filtration module
6 first permeate line
8 first retentate line
10 first flotation module
12 first mud treatment module
14 first residual process water line
16 first solids separation line
18 first microfiltration module
20 second mud treatment module
22 second permeate line
24 second retentate line
26 first process water circuit
28 third mud treatment module
30 second process water supply line
32 second flotation module
34 second residual process water line
36 second solids separation line
38 second microfiltration module
40 fourth mud treatment module
42 third permeate line
44 fourth permeate line
46 second process water circuit
48 third retentate line
50 fifth mud treatment module
52 control unit
54 pipe water supply line
56 pipe water treatment module
58 solid phase discharge line
60 solid phase reservoir
62 first liquid phase supply line
64 second liquid phase supply line
66 solid phase discharge line
68 capture receptacle
S.1.a step 1.a.
S.1.b.i step 1.b.i.
S.1.b.ii step 1.b.ii.
S.1.c.i step 1.c.i.
S.1.c.ii step 1.c.ii.
S.1.d.i step 1.d.i.
S.1.d.ii step 1.d.ii.
S.2.a step 2.a.
S.2.b.i step 2.b.i.
S.2.b.ii step 2.b.ii.
S.2.c.i step 2.c.i.
S.2.c.ii step 2.c.ii.

1. A water treatment plant for the treatment of process water of two process water circuits (26, 46), a first process water supply line (2) being configured to feed a first process water of a first of the process water circuits (26) into a process water filtration module (4) in a first purification circuit, the process water filtration module (4) being connected to a first flotation module (10) via a first permeate line (6), the first flotation module (10) being connected to a first microfiltration module (18) via a first residual process water line (14), a second permeate line (22) being configured to return a second permeate back into the first process water circuit (26) from the first microfiltration module (18), a second process water supply line (30) being configured to feed a second process water of the second process water circuit (46) into the first flotation module (10) and/or a second flotation module (32) in a second purification circuit, the first flotation module (10) and the second flotation module (32) being connected to the first microfiltration module (18) and a second microfiltration module (38), respectively, via the first residual process water line and a second residual process water line (34), respectively, and a second permeate line (22), a third permeate line (42) and/or a fourth permeate line (44) being configured to feed a third permeate from the second microfiltration module (38) into the first process water circuit (26) and/or the second process water circuit (46).

2. The water treatment plant according to claim 1, wherein the process water filtration module (4) is connected to at least one mud treatment module (12, 20, 28, 40, 50) via a first retentate line (8), the first flotation module (10) is connected to at least one mud treatment module (12, 20, 28, 40, 50) via a first solids separation line (16), the first microfiltration module (18) is connected to at least one mud treatment module (12, 20, 28, 40, 50) via a second retentate line (24), the second flotation module (32) is connected to at least one mud treatment module (12, 20, 28, 40, 50) via a second solids separation line (36) and/or the second microfiltration module (38) is connected to at least one mud treatment module (12, 20, 28, 40, 50) via a third retentate line (48).

3. The water treatment plant according to claim 1, characterized by a control unit (52) and a data acquisition unit, the data acquisition unit being configured to record an amount of the first process water in the first process water circuit, a control valve being configured to be switched in such a manner that the third permeate is fed into the first process water circuit (26) from the second purification circuit, in particular from the second microfiltration module (38), and it is ruled out that the third permeate is fed into the second process water circuit (46), if the control unit (52) detects that the recorded amount of the process water in the first process water circuit (26) is less than or equal to a defined value, and the control valve being configured to be switched in such a manner that the third permeate is fed into the second process water circuit (46) from the second purification circuit, in particular from the second microfiltration module (38), and it is ruled out that the third permeate is fed into the first process water circuit (26), if the control unit (52) detects that the amount of the process water in the first process water circuit (26) is greater than the defined value.

4. The water treatment plant according to claim 2, wherein the at least one mud treatment module (12, 20, 28, 40, 50) comprises a two-phase centrifuge, by means of which the first retentate, the second retentate, the third retentate, the fourth retentate, the first solids separation and/or the second solids separation is/are separatable into a solid phase and a liquid phase.

5. The water treatment plant according to claim 4, characterized by at least one liquid phase supply line (62, 64), through which the liquid phase is fed into the first process water circuit (26) and/or into the second process water circuit (46).

6. The water treatment plant according to claim 1, characterized by at least one pipe water supply line (54, 56), through which the pipe water is fed into the first microfiltration module (18) and/or into the second microfiltration module (38).

7. The water treatment plant according to claim 6, characterized by at least one pipe water treatment module (56), which is disposed in such a way that pipe water in the at least one pipe water supply line (54) flows through the pipe water treatment module (56), in particular before being fed into the first microfiltration module (18) and/or into the second microfiltration module (38).

8. The water treatment plant according to claim 7, wherein the pipe water treatment module (56) comprises a water softening plant, in particular a duplex water softening plant, a pipe water filtration module, in particular in the form of the process water filtration module (4), and/or an enrichment module, configured to enrich the pipe water, in particular with sulfuric acid and/or sodium hydroxide solution.

9. A purification plant, comprising two process water circuits (26, 46), characterized by a water treatment plant according to claim 1.

10. A method for water treatment of process water of two process water circuits (26, 46), the method for water treatment of a first of the process water circuits (26), comprising the following steps:
1.a. supplying a first process water of the first process water circuit (26) to a process water filtration module (4) via a first process water supply line (2), the first process water being separated into a first permeate and a first retentate in said process water filtration module (4);
1.b.i feeding the first permeate from the process water filtration module (4) into a first flotation module (10) via a first permeate line (6), the first permeate being separated into a first solids separation and a first residual process water in said first flotation module (10);
1.c.i. feeding the first residual process water from the first flotation module (10) into a first microfiltration module (18) via a first residual process water line (14), the residual process water being separated into a second permeate and a second retentate in said first microfiltration module (18); and
1.d.i. discharging the second permeate from the first microfiltration module (18) into the first process water circuit (26) via a second permeate line (22);
the method for water treatment of the second process water circuit (46) comprising the following steps:
2.a. supplying a second process water of the second process water circuit (46) into the first flotation module (10) or a second flotation module (32) via a second process water supply line, the second process water being separated into a second solids separation and a second residual process water in the first flotation module (10) or in the second flotation module (32); and
2.b.i. feeding the second residual process water from the first flotation module (10) or the second flotation module (32) into the first microfiltration module (18) and a second microfiltration module (38), respectively, via the first residual process water line (14) and a second residual process water line (34), respectively, the second residual process water being separated into a third permeate and a third retentate in the first microfiltration module (18) or in the second microfiltration module (38); and
2.c.i. discharging the third permeate from the first microfiltration module (18) or the second microfiltration module (38) into the first process water circuit (26) and/or the second process water circuit (46) via the second permeate line (22), a third permeate line (42) and/or a fourth permeate line (44).

11. The method according to claim 10, characterized by at least one of the following steps:
1.b.ii. discharging the first retentate from the process water filtration module (4) to a first mud treatment module (12) via a first retentate line (8);
1.c.ii. discharging the first solids separation from the first flotation module (10) into the first mud treatment module (12) and/or a second mud treatment module (20) via a first solids separation line (16);
1.d.ii. discharging the second retentate from the first microfiltration module (18) into the first mud treatment module (12), the second mud treatment module (20) and/or a third mud treatment module (28) via a second retentate line (24);
2.b.ii discharging the second solids separation from the first flotation module (10) via the first solids separation line (16) or from the second flotation module (32) via a second solids separation line (36) into the first mud treatment module (12), the second mud treatment module (20), the third mud treatment module (28) and/or a fourth mud treatment module (40); and
2.c.ii. discharging the third retentate from the first microfiltration module (18) or the second microfiltration module (38) into the first mud treatment module (12), the second mud treatment module (20), the third mud treatment module (28), the fourth mud treatment module (40) and/or a fifth mud treatment module (50) via the second retentate line (24) and a third retentate line (48), respectively.

12. The method according to claim 10, wherein it is determined before step 2.c.i. whether an amount of the process water in the first process water circuit (26) is less than or equal to a defined value, the third permeate being fed from the second microfiltration module (38) into the first process water circuit (26) if the recorded amount of the process water in the first process water circuit (26) is less than or equal to the defined value, and the third permeate being fed from the second microfiltration module (38) into the second process water circuit (46) if the amount of the process water in the first process water circuit (26) is greater than the defined value.

13. The method according to claim 11, wherein the first retentate, the second retentate, the third retentate, the fourth retentate, the first solids separation and/or the second solids separation is/are (each) separated into a solid phase and a liquid phase by means of a two-phase centrifuge in the first mud treatment module (12), the second mud treatment module (20), the third mud treatment module (28), the fourth mud treatment module (40) and/or the fifth mud treatment module (50).

14. The method according to claim 13, wherein the liquid phase is fed into the first process water circuit (26) and/or into the second process water circuit (46) via liquid phase supply line (62, 64).

15. The method according claim 10, wherein pipe water is fed into the first microfiltration module (18) via a first pipe water supply line (54) and/or into the second microfiltration module (38) via a second pipe water supply line the pipe water flowing through a pipe water treatment module (56) in particular before being supplied to the first microfiltration module (18) and/or the second microfiltration module (38), the throughflow of the pipe water treatment module (56) in particular comprising a throughflow of a water softening plant, a throughflow of a pipe water filtration module and/or a throughflow of an enrichment module, in which the pipe water is enriched, in particular with sulfuric acid and/or sodium hydroxide solution.
